(19) United States
(12) Patent Application Publication
(10) Pub. No.: US 2026/0147661 A1
(43) Pub. Date: May 28, 2026

(54) AUTOMATED ANOMALY DETECTION AND REMEDIATION SYSTEM OF A COMPUTER NETWORK

(71) Applicant: Express Scripts Strategic Development, Inc., St. Louis, MO (US)

(72) Inventors: Kuochen Li, Avon, CT (US); Ramesh Karnam, Marlton, NJ (US); David Janson, Bloomfield, CT (US)

(21) Appl. No.: 18/956,115

(22) Filed: Nov. 22, 2024

(51) Int. Cl. G06F 11/07

(52) U.S. Cl. CPC G06F 11/0793

(57) ABSTRACT

Apparatuses, systems, and methods relate to technology that identifies a dataset that is associated with execution of an automated process, determines that a trigger has occurred, where the trigger includes that source data of the dataset is modified through the automated process, and identifies a rule set associated with the dataset. The technology further, in response to the trigger being determined as occurred, determines whether an anomaly exists in the source data based on the rule set, where the anomaly includes an error in the source data, and automatically adjusts the source data to mitigate the error when the anomaly exists in the source data.

### TECHNICAL FIELD

The present disclosure relates to an enhanced system to identify anomalies in rapidly changing data of a computing network. In detail, examples relate to an enhanced system that can identify the anomalies based in real time, and address the anomalies by refreshing the data and/or adjusting the computer network.

### BACKGROUND

Computing systems have become increasingly complex and sophisticated. Correspondingly, the workloads, reliance and trust in computing systems has increased. For example, computing systems can store and operate on different types of sensitive data and support numerous distinct technologies.

### BRIEF DESCRIPTION OF THE SEVERAL VIEWS OF THE DRAWINGS

The various advantages of the examples of the present disclosure will become apparent to one skilled in the art by reading the following specification and appended claims, and by referencing the following drawings, in which:

FIG. 1 is a diagram of an example of an automated anomaly detection and correction system according to an example;

FIG. 2 is a diagram of an example of a data quality measurement process according to an example;

FIG. 3 is a flowchart of an example of identifying and healing anomalies according to an example;

FIG. 4 is a flowchart of an example of identifying anomalies and adjusting source data according to an example;

FIG. 5 illustrates a block diagram of an example of a computing system according to an example;

FIG. 6 is a block diagram of an example patient management platform that may be deployed within the system of FIG. 1, according to some examples;

FIG. 7 is a functional block diagram of an example neural network that can be used for the inference engine or other functions (e.g., engines) as described herein to produce a predictive model; and

FIG. 8 is a table illustrating results of the technical solution described herein.

### DETAILED DESCRIPTION

Computing systems can operate over a wide array of data and data types. Furthermore, numerous platforms exist to store, process and change the data. Such platforms can be adapted to different purposes and computing architectures resulting in greater efficiency for particular use cases. Monitoring the vast amount of data in real time is impossible for human beings to perform. For example, an enterprise can store 10 petabytes of data, or more than 23 billion files. Such a volume of data is impossible to manually track in any practical way.

Adding to the complexity of such situations is that changes can be autonomously made by the existing computing systems. For example, enterprises can permit users to view and modify data. The data is then automatically updated on servers (e.g., via backend software programs). Such processes can be automatic, meaning that human review of the modifications is not performed. In some examples, data is automatically updated based on existing criteria. For example, user accounts can be automatically cancelled due to a certain date being reached (e.g., expiration), non-payment, certain etc. Indeed, such automated processes are becoming increasingly common as enterprises seek to reduce cost, increase quality and remain competitive.

Such automation is not without errors, however. Such errors can be costly in terms of downtime, customer satisfaction, competitiveness, data quality and efficiency. For example, often such errors are not immediately detected until noticed by an end user. The end user can be “locked out” from accessing the data for example (e.g., electronic account erroneously deleted) or notice that the data is incorrect. In some cases, processes can begin to fail as the errors accumulate or operate on faulty data, resulting in down time and lowered efficiency. That is, errors are not detected in real time and are therefore unaddressed until a problem occurs.

That is, given the vast quantities of information, enterprises aim to minimize and reduce human intervention. Consequently, much of the data is not reviewed by an administrator of the enterprise systems either prior to or post modification. Thus, errors can go unnoticed for lengthy periods of time, and until the number of errors reaches a significant level that causes systems to fail and/or end users to provide error reports.

Furthermore, addressing data errors often can consume massive amounts of processing power, computer resources and man hours. As noted above, enterprise systems typically house a massive quantity of data that is impossible for a human to manually review in significant detail. The relationships can also be complex. For example, in a relational database, data can be stored in clearly defined, compact tables, which can connect or relate the data held in different tables. Relationships between the data in different tables can be one-to-one, one-to-many, and many-to-many. To be able to accurately identify these relationships, an administrator examines the data and develops an understanding of what business rules apply to the data and tables. Thus, tracing and remedying a source of errors is an overwhelmingly complex task which a human is unable to perform mentally in real time, particularly given the large quantity of data and complexity relationships between data.

Moreover, in many cases the errors can be compounded. That is, computer processes that operate on faulty data produce faulty outputs, which in turn can affect other computer processes, compounding the errors multi-fold. Thus, multiple databases and processes would be adjusted to correct the compounded errors. Furthermore, as the errors are compounded, identifying the cause of the errors becomes increasingly difficult and perplexing. Thus, the computer resources and human resources to analyze the compounded errors significantly increases. Furthermore, since the errors become more widespread, many different computing systems and platforms are adjusted to mitigate the errors resulting in further down time, increasing processing resources, energy and memory to adjust and correct the computer systems.

Moreover, existing computing systems are unable to capture and persist Service Level Agreements (SLAs) consistently for batch processes across upstream and downstream applications. SLAs can define the level of service expected from an entity, laying out metrics by which service is measured, as well as remedies should service levels not be achieved. Consequently, there is a lack of ways to measure the performance against the SLAs. Furthermore, there is no time sensitive alert triggering that is coupled with the existing notification systems (e.g., Enterprise Service Health Dashboard (ESHD)), to avoid potential operational impacts. Moreover, there is a difficulty in defining business impact when there are platform outages across multiple applications. The data pipeline definitions and measurements for service level indicators (SLIs) may fluctuate across the platforms for examples.

Thus, prior computing systems can suffer from multiple technical difficulties. Namely, errors on computing systems become widespread, are impossible to identify in real time by a human being, are difficult to remedy, have difficulty monitoring and meeting SLAs, fail to have time sensitive alerts, consume significant resources to mitigate, etc. Furthermore, prior systems suffer from increased down time, increased processing resources, increased energy consumption and increased memory usage to remedy such errors. Moreover, such prior systems are driven by user notifications or identifications, resulting in significant delays in realizing that errors are occurring resulting in compounded errors.

Enhanced examples as described remedy the above technical difficulties with a technical solution that provides significant enhancements over the prior examples. Examples herein can automatically identify errors in real time based on automated processes which is impossible for humans to execute, resulting in significant enhancements. Furthermore, examples can diagnose the errors prior to the errors becoming widespread and affecting multiple systems, reducing the overhead (e.g., processing power, processing resources, energy, memory, downtime etc.) mentioned above to remedy the errors. Furthermore, some examples can automatically remedy the errors in real time to significantly reduce downtime, human intervention and processing resources. Moreover, enhanced examples herein can monitor and meet SLAs.

To implement the above technical solution, examples identify a dataset that is associated with execution of an automated process, determine that a trigger has occurred, where the trigger includes that source data of the dataset is modified through the automated process, and identify a rule set associated with the dataset. Examples further, in response to the trigger being determined as occurred, determine whether an anomaly exists in the source data based on the rule set, where the anomaly includes an error in the source data, and automatically adjust the source data to mitigate the error when the anomaly exists in the source data.

Furthermore, examples can include a framework that links various specialized platforms, components and modules (e.g., a data catalog platform that is a cloud-based workflow automation platform that enables enterprise organizations to improve operational efficiencies, an anomaly correction platform that is a customized event stream processing (ESP) monitoring system, an ESP monitor, etc.). Enhanced technical solutions involves loading ESP monitoring data (e.g., application data) into a table (e.g., a table hosted by the data catalog platform and/or the anomaly correction platform), utilizing the ESP monitoring data for defining the monitoring timeframe, and employing data catalog platform to conduct quality checks or data validations upon the completion of a data pipeline. By integrating Robotic Process Automation (RPA) with data measures, the examples can achieve automatic data resynchronization and/or self-healing capabilities, resulting in millions of savings a year, the elimination of human intervention, reduced computing resources, lower energy systems and increased confidence in systems.

Examples can capture SLA information through a batch management intake form. Examples can further persist the SLA information into a service application (e.g., anomaly correction platform and data catalog platform) knowledge base. Examples can capture the SLA information in a source repository to maintain a historical database of the SLA information. Examples can further create a data synchronization process between the service application and the source repository on a regular basis. Examples can measure the batch performance against the SLAs using various tools. Examples can further quantify the impact of SLA violations. SLA measurements can include pipeline measures such as pipeline delays and pipeline status (e.g., failures).

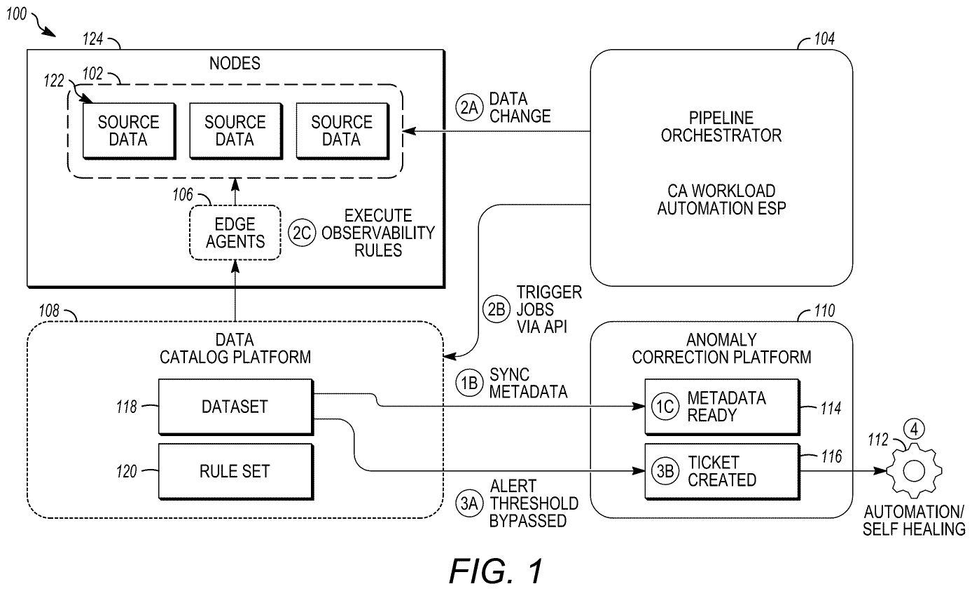

Turning now to FIG. 1, an approach for an automated anomaly detection and correction system 100 is illustrated. Initially, a data catalog platform 108 establishes a connection to data sources 102, and generates a dataset 118 in the data catalog platform 108. The dataset 118 includes and/or is associated with structures that are monitored for anomalies. In some examples, the dataset 118 includes pointers or references to the data sources 102 (e.g., databases, nodes, servers storing data, etc.) such as source data 122. The source data 122 can be generated and/or modified by an automated process (e.g., computer operation, process, batch process, etc.). The source data 122 can be moved into different databases for example.

The data catalog platform 108 generates rule set 120 (e.g., a series of rules that comprises queries and/or commands to execute against data) to check source data 122 (e.g., healthcare data such as accounts, personally identifiable information, medical claims, etc.) of the dataset 118 for errors or unusual behavior. In some cases, an expert system engineer can generate the rule set 120 to define normal operating conditions of the automated anomaly detection and correction system 100. If certain criteria of the rules of the rule set 120 are met, then an anomaly (e.g., missing data, incorrect data, incorrect changes to accounts, data corruption, etc.) can be detected. In some cases however, doing so can prove to be far too complicated and exhausting for an expert system engineer to complete. In such examples, the data catalog platform 108 can generate the rule set 120 automatically (e.g., with machine learning models) and based on errors and corrections to the errors.

For example, the data catalog platform 108 can include a first machine learning model that is trained on anomalous data and non-anomalous data. The data catalog platform 108 can learn to identify when anomalies occur and provide an indication of a corresponding anomaly such as salient features of datasets 118 that are anomalous. The first machine learning model can be a supervised learning model. In some examples, the first machine learning model is trained based on previous errors from historical source data, and generates the rule set 120 with the first machine learning model based on the training. In some examples the first machine learning model includes a training model (e.g., anomalous data and non-anomalous data and/or a dataset used to train a machine learning algorithm) and a supervised learning model that is trained on the training model.

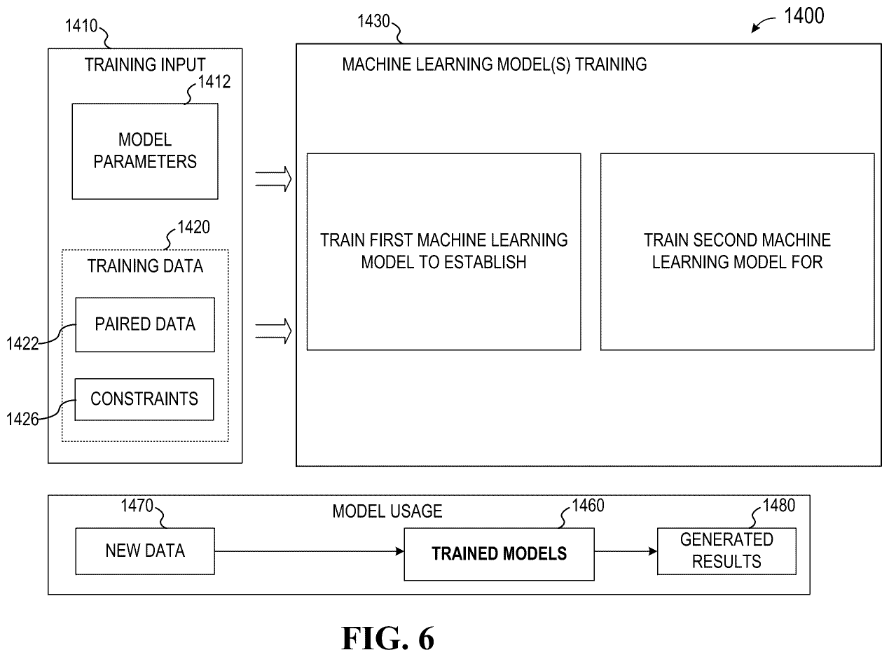

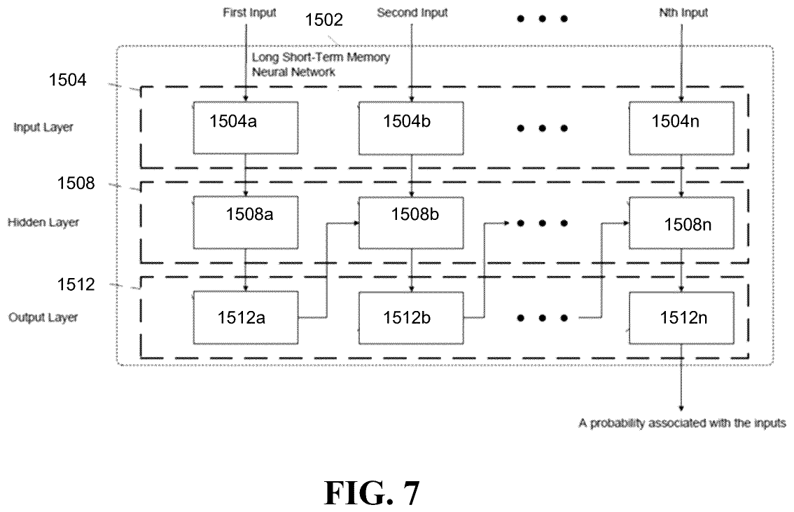

In other examples, the first machine learning model can be a generative model. A user (engineer or non-engineer) can provide a natural language prompt to the first machine learning model to generate computer code to analyze the dataset 118. The first machine learning model can receive the prompt and generate the computer code. The computer code can be stored as rules of the rule set 120 which are executed to analyze the source data 122. That is, in some examples, a generative artificial intelligence model receives a natural language prompt associated with identification of an anomaly (error), generates computer code to identify the anomaly based on the natural language prompt. The computer code can be stored into the rule set 120. Such examples include enhancements in that rules of the rule set 120 can be generated in a streamlined manner and with a combined expertise of human knowledge and machine learning logic. The first machine learning model can be implemented according to the machine learning model 1400 (FIG. 6) and/or neural network 1502 (FIG. 7) described below.

The queries for the rules of the rule set 120 can be complicated, and prone to error. Therefore, incorporating the generative artificial intelligence model can provide significant enhancements in terms of time and effectiveness. One such query for HEV (Health E View) (CRP Condition Risk Profile) Validation—measures again CCDR (Consumer Centric Data Repository) is shown below in pseudocode I:

### Datasets:

Control Client Analysis (CCA):
CCDR_HEV_MART.CONDN_RISK_PROF_CCA_TKCDWHE2_CURR
SELECT CLIENT_ID, CLIENT_NM, SUM (COUNT) AS CNT FROM
(WITH CA AS ( SELECT
A.CLIENT_ID, MAX (A.CLIENT_NM) AS CLIENT_NM,
B.ACCT_NUM, MAX (B.ACCT_NM) AS ACCT_NM
FROM HEV_MART.CLIENT_BEN_STG B, HEV_MART.CLIENT_STG A
WHERE A.CLIENT_ID = B.CLIENT_ID AND
(A.CLIENT_ID IN
(‘3FBZ7B11’,’0053672’,’0002542’,’7002720’,’0046213’,’0024979’,’0056307’,

| | |
|---|---|
| ‘TQ5NY711’, | ‘0047775’, |
| ‘0041529’, | ‘0047661’, |
| ‘0016552’, | ‘0012556’, |
| ‘0040224’, | ‘527Z8911’, |
| ‘7015775’, | ‘0010495’, |
| ‘0012491’, | ‘7006017’, |
| ‘0040024’, | ‘0046274’, |
| ‘0031148’, | ‘7040862’, |

‘0015646’)) GROUP BY A.CLIENT_ID, B.ACCT_NUM),
FQ AS ( SELECT
DISTINCT CA.CLIENT_ID,
CA.CLIENT_NM, CRP.RCD_TY_DESC,
CRP.CHNL_SRC_CD, CRP.FACT_ID,
MAX (SAE_LAST_RUN_DT) AS LASTRUN,
COUNT (DISTINCT CRP.INDIV_ENTERPRISE_ID) AS
COUNT FROM HEV_MART.CONDN_RISK_PROF_STG CRP,
HEV_MART.MEMBR_STG MB, CA
WHERE CRP.INDIV_ENTERPRISE_ID =
MB.INDIV_ENTERPRISE_ID AND MB.ACCT_NUM =
CA.ACCT_NUM AND CRP.MODEL_JOB_EXECN_ID =
(SELECT MAX(JOB_EXECN_ID) FROM SAE_MDR.JOB)
AND CRP.CHNL_SRC_CD = ‘SAE’ GROUP BY CA.CLIENT_ID,
CA.CLIENT_NM, CRP.RCD_TY_DESC,
CRP.CHNL_SRC_CD, CRP.FACT_ID) SELECT
* FROM FQ) GROUP BY CLIENT_ID, CLIENT_NM
CCDR_HEV_MART.CONDN_RISK_PROF_CCA_TKCDWHE2_PREV
SELECT CLIENT_ID, CLIENT_NM, SUM (COUNT)
AS CNT FROM (WITH CA AS
( SELECT A.CLIENT_ID, MAX
(A.CLIENT_NM) AS CLIENT_NM, B.ACCT_NUM,
MAX (B.ACCT_NM) AS ACCT_NM FROM
HEV_MART.CLIENT_BEN B, HEV_MART.CLIENT A
WHERE A.CLIENT_ID = B.CLIENT_ID AND
(A.CLIENT_ID IN
(‘3FBZ7B11’,’0053672’,’0002542’,’7002720’,’0046213’,’0024979’,’0056307’,

| | |
|---|---|
| ‘TQ5NY711’, | ‘0047775’, |
| ‘0041529’, | ‘0047661’, |
| ‘0016552’, | ‘0012556’, |
| ‘0040224’, | ‘527Z8911’, |
| ‘7015775’, | ‘0010495’, |
| ‘0012491’, | ‘7006017’, |
| ‘0040024’, | ‘0046274’, |
| ‘0031148’, | ‘7040862’, |

‘0015646’)) GROUP BY A.CLIENT_ID, B.ACCT_NUM),
FQ AS ( SELECT
DISTINCT CA.CLIENT_ID,
CA.CLIENT_NM, CRP.RCD_TY_DESC,
CRP.CHNL_SRC_CD, CRP.FACT_ID,
MAX (SAE_LAST_RUN_DT) AS LASTRUN,
COUNT (DISTINCT CRP.INDIV_ENTERPRISE_ID) AS
COUNT FROM HEV_MART.CONDN_RISK_PROF CRP,
HEV_MART.MEMBR MB, CA
WHERE CRP.INDIV_ENTERPRISE_ID =
MB.INDIV_ENTERPRISE_ID AND MB.ACCT_NUM =
CA.ACCT_NUM AND CRP.MODEL_JOB_EXECN_ID =
(SELECT MAX(JOB_EXECN_ID) FROM SAE_MDR.JOB WHERE
JOB_EXECN_ID < (SELECT MAX(JOB_EXECN_ID) FROM SAE_MDR.JOB))
AND CRP.CHNL_SRC_CD = ‘SAE’ GROUP BY CA.CLIENT_ID,
CA.CLIENT_NM, CRP.RCD_TY_DESC,
CRP.CHNL_SRC_CD, CRP.FACT_ID) SELECT
* FROM FQ) GROUP BY CLIENT_ID, CLIENT_NM

Key Fact Analysis (KFA):
CCDR_HEV_MART.CONDN_RISK_PROF_KFA_TKCDWHE2_CURR
SELECT SUM (COUNT) AS CNT FROM ( SELECT a.RCD_TY_DESC,
a.CHNL_SRC_CD, COUNT (*) AS COUNT,
a.MODEL_JOB_EXECN_ID, a.FACT_ID,
a.SAE_LAST_RUN_DT AS lastrun FROM
HEV_MART.CONDN_RISK_PROF_STG a WHERE FACT_ID IN

| | |
|---|---|
| (‘CGN:FCT:1060’, | ‘CGN:FCT:1061’, |
| ‘CGN:FCT:1062’, | ‘CGN:FCT:1063’, |
| ‘CGN:FCT:1064’, | ‘CGN:FCT:1065’, |
| ‘CGN:FCT:1327’, | ‘CGN:FCT:1328’, |
| ‘CGN:FCT:1329’, | ‘CGN:FCT:1330’, |
| ‘CGN:FCT:1336’, | ‘CGN:FCT:298’, |
| ‘CGN:FCT:299’, | ‘CGN:FCT:300’, |
| ‘CGN:FCT:302’, | ‘CGN:FCT:303’, |
| ‘CGN:FCT:304’, | ‘CGN:FCT:356’, |
| ‘CGN:FCT:361’, | ‘CGN:FCT:368’, |
| ‘CGN:FCT:370’, | ‘CGN:FCT:371’, |
| ‘CGN:FCT:486’, | ‘CGN:FCT:487’, |
| ‘CGN:FCT:488’, | ‘CGN:FCT:489’, |
| ‘CGN:FCT:490’, | ‘CGN:FCT:491’, |
| ‘CGN:FCT:492’, | ‘CGN:FCT:494’, |
| ‘CGN:FCT:495’, | ‘CGN:FCT:570’, |

‘CGN:FCT:585’) AND a.MODEL_JOB_EXECN_ID = (SELECT
MAX(JOB_EXECN_ID) FROM SAE_MDR.JOB) AND
MEMBR_FACT_VALID_IND = ‘Y’ GROUP BY a.RCD_TY_DESC,
a.CHNL_SRC_CD, a.MODEL_JOB_EXECN_ID, a.FACT_ID,
a.SAE_LAST_RUN_DT ORDER BY a.fact_id) CURR

CCDR_HEV_MART.CONDN_RISK_PROF_KFA_TKCDWHE2_PREV
SELECT SUM (COUNT) AS CNT FROM ( SELECT a.RCD_TY_DESC,
a.CHNL_SRC_CD, COUNT (*) AS COUNT,
a.MODEL_JOB_EXECN_ID, a.FACT_ID,
a.SAE_LAST_RUN_DT AS lastrun FROM
HEV_MART.CONDN_RISK_PROF a WHERE FACT_ID IN

| | |
|---|---|
| (‘CGN:FCT:1060’, | ‘CGN:FCT:1061’, |
| ‘CGN:FCT:1062’, | ‘CGN:FCT:1063’, |
| ‘CGN:FCT:1064’, | ‘CGN:FCT:1065’, |
| ‘CGN:FCT:1327’, | ‘CGN:FCT:1328’, |
| ‘CGN:FCT:1329’, | ‘CGN:FCT:1330’, |
| ‘CGN:FCT:1336’, | ‘CGN:FCT:298’, |
| ‘CGN:FCT:299’, | ‘CGN:FCT:300’, |
| ‘CGN:FCT:302’, | ‘CGN:FCT:303’, |
| ‘CGN:FCT:304’, | ‘CGN:FCT:356’, |
| ‘CGN:FCT:361’, | ‘CGN:FCT:368’, |
| ‘CGN:FCT:370’, | ‘CGN:FCT:371’, |
| ‘CGN:FCT:486’, | ‘CGN:FCT:487’, |
| ‘CGN:FCT:488’, | ‘CGN:FCT:489’, |
| ‘CGN:FCT:490’, | ‘CGN:FCT:491’, |
| ‘CGN:FCT:492’, | ‘CGN:FCT:494’, |
| ‘CGN:FCT:495’, | ‘CGN:FCT:570’, |

‘CGN:FCT:585’) AND a.MODEL_JOB_EXECN_ID = (SELECT
MAX(JOB_EXECN_ID) FROM SAE_MDR.JOB WHERE JOB_EXECN_ID <
(SELECT MAX(JOB_EXECN_ID) FROM SAE_MDR.JOB)) AND
MEMBR_FACT_VALID_IND = ‘Y’ GROUP BY a.RCD_TY_DESC,
a.CHNL_SRC_CD, a.MODEL_JOB_EXECN_ID, a.FACT_ID,
a.SAE_LAST_RUN_DT ORDER BY a.fact_id) CURR

Theracare Fact Analysis (TFA):

CCDR_HEV_MART.CONDN_RISK_PROF_TFA_TKCDWHE2_CURR
select VAL2.model_id, VAL1.cnt from (SELECT test.MODEL_DPLYMNT_ID,SUM
(COUNT) AS CNT FROM ( SELECT a.RCD_TY_DESC, a.CHNL_SRC_CD,
COUNT (*) AS COUNT, a.MODEL_JOB_EXECN_ID, a.FACT_ID,
a.MODEL_DPLYMNT_ID, a.SAE_LAST_RUN_DT AS lastrun FROM
HEV_MART.CONDN_RISK_PROF_STG a WHERE FACT_ID IN
(‘CGN:FCT:1052’, ‘CGN:FCT:1053’, ‘CGN:FCT:1054’, ‘CGN:FCT:1056’,
‘CGN:FCT:1057’, ‘CGN:FCT:1058’, ‘CGN:FCT:1059’, ‘CGN:FCT:1072’,
‘CGN:FCT:1073’, ‘CGN:FCT:1074’, ‘CGN:FCT:1075’, ‘CGN:FCT:1076’,
‘CGN:FCT:1077’, ‘CGN:FCT:1078’, ‘CGN:FCT:1079’, ‘CGN:FCT:1080’,
‘CGN:FCT:1081’, ‘CGN:FCT:1082’, ‘CGN:FCT:1083’, ‘CGN:FCT:1084’,
‘CGN:FCT:1085’, ‘CGN:FCT:1271’, ‘CGN:FCT:1272’, ‘CGN:FCT:1273’,
‘CGN:FCT:1274’, ‘CGN:FCT:1275’, ‘CGN:FCT:1276’, ‘CGN:FCT:1277’,
‘CGN:FCT:1278’, ‘CGN:FCT:1279’, ‘CGN:FCT:1280’, ‘CGN:FCT:1281’,
‘CGN:FCT:1282’, ‘CGN:FCT:1283’, ‘CGN:FCT:1284’, ‘CGN:FCT:1285’,
‘CGN:FCT:1286’, ‘CGN:FCT:1287’, ‘CGN:FCT:1288’, ‘CGN:FCT:1332’,
‘CGN:FCT:1333’, ‘CGN:FCT:1343’, ‘CGN:FCT:1344’, ‘CGN:FCT:1345’,
‘CGN:FCT:1346’, ‘CGN:FCT:1361’, ‘CGN:FCT:1362’, ‘CGN:FCT:1363’,
‘CGN:FCT:1376’, ‘CGN:FCT:1377’, ‘CGN:FCT:1383’, ‘CGN:FCT:1384’,
‘CGN:FCT:1385’, ‘CGN:FCT:1386’, ‘CGN:FCT:1387’, ‘CGN:FCT:1388’,
‘CGN:FCT:1433’, ‘CGN:FCT:1434’, ‘CGN:FCT:1435’, ‘CGN:FCT:1441’,
‘CGN:FCT:1442’, ‘CGN:FCT:1464’, ‘CGN:FCT:1465’, ‘CGN:FCT:1500’,
‘CGN:FCT:1501’, ‘CGN:FCT:1502’, ‘CGN:FCT:1503’, ‘CGN:FCT:1504’,
‘CGN:FCT:1511’, ‘CGN:FCT:1512’, ‘CGN:FCT:1513’, ‘CGN:FCT:1533’,
‘CGN:FCT:1534’, ‘CGN:FCT:1535’, ‘CGN:FCT:1536’, ‘CGN:FCT:1537’,
‘CGN:FCT:1538’, ‘CGN:FCT:1548’, ‘CGN:FCT:1549’, ‘CGN:FCT:1551’,
‘CGN:FCT:1552’, ‘CGN:FCT:1553’, ‘CGN:FCT:1554’, ‘CGN:FCT:1555’,
‘CGN:FCT:1556’, ‘CGN:FCT:1568’, ‘CGN:FCT:1569’, ‘CGN:FCT:1570’,
‘CGN:FCT:1571’, ‘CGN:FCT:1572’, ‘CGN:FCT:1573’, ‘CGN:FCT:1574’,
‘CGN:FCT:1579’, ‘CGN:FCT:1580’, ‘CGN:FCT:1583’, ‘CGN:FCT:1584’,
‘CGN:FCT:1585’, ‘CGN:FCT:1651’, ‘CGN:FCT:1655’, ‘CGN:FCT:1669’,
‘CGN:FCT:1670’, ‘CGN:FCT:1671’, ‘CGN:FCT:1672’, ‘CGN:FCT:1673’,
‘CGN:FCT:1725’, ‘CGN:FCT:1726’, ‘CGN:FCT:1727’, ‘CGN:FCT:1728’,
‘CGN:FCT:1729’, ‘CGN:FCT:1730’, ‘CGN:FCT:1731’, ‘CGN:FCT:1732’,
‘CGN:FCT:1747’, ‘CGN:FCT:1748’, ‘CGN:FCT:1749’, ‘CGN:FCT:1750’,
‘CGN:FCT:1759’, ‘CGN:FCT:1817’, ‘CGN:FCT:1818’, ‘CGN:FCT:1819’,
‘CGN:FCT:1820’, ‘CGN:FCT:1847’, ‘CGN:FCT:1848’, ‘CGN:FCT:1849’,
‘CGN:FCT:1850’, ‘CGN:FCT:748’, ‘CGN:FCT:749’, ‘CGN:FCT:750’,
‘CGN:FCT:751’, ‘CGN:FCT:752’, ‘CGN:FCT:753’, ‘CGN:FCT:754’,
‘CGN:FCT:755’, ‘CGN:FCT:756’, ‘CGN:FCT:757’, ‘CGN:FCT:758’,
‘CGN:FCT:759’, ‘CGN:FCT:760’, ‘CGN:FCT:761’, ‘CGN:FCT:762’,
‘CGN:FCT:763’, ‘CGN:FCT:764’, ‘CGN:FCT:765’, ‘CGN:FCT:766’,
‘CGN:FCT:767’, ‘CGN:FCT:768’, ‘CGN:FCT:769’, ‘CGN:FCT:770’,
‘CGN:FCT:771’, ‘CGN:FCT:772’, ‘CGN:FCT:773’, ‘CGN:FCT:774’,
‘CGN:FCT:775’, ‘CGN:FCT:776’, ‘CGN:FCT:777’, ‘CGN:FCT:778’,
‘CGN:FCT:779’, ‘CGN:FCT:780’, ‘CGN:FCT:781’, ‘CGN:FCT:782’,
‘CGN:FCT:783’, ‘CGN:FCT:784’, ‘CGN:FCT:785’, ‘CGN:FCT:786’,
‘CGN:FCT:787’, ‘CGN:FCT:788’, ‘CGN:FCT:789’, ‘CGN:FCT:790’,
‘CGN:FCT:791’, ‘CGN:FCT:792’, ‘CGN:FCT:793’, ‘CGN:FCT:794’,
‘CGN:FCT:795’, ‘CGN:FCT:796’, ‘CGN:FCT:797’, ‘CGN:FCT:798’,
‘CGN:FCT:799’, ‘CGN:FCT:800’, ‘CGN:FCT:801’, ‘CGN:FCT:802’,
‘CGN:FCT:803’, ‘CGN:FCT:804’, ‘CGN:FCT:805’, ‘CGN:FCT:806’,
‘CGN:FCT:807’, ‘CGN:FCT:808’, ‘CGN:FCT:809’, ‘CGN:FCT:810’,
‘CGN:FCT:811’, ‘CGN:FCT:812’, ‘CGN:FCT:813’, ‘CGN:FCT:814’,
‘CGN:FCT:815’, ‘CGN:FCT:816’, ‘CGN:FCT:817’, ‘CGN:FCT:818’,
‘CGN:FCT:819’, ‘CGN:FCT:820’, ‘CGN:FCT:821’, ‘CGN:FCT:822’,
‘CGN:FCT:823’, ‘CGN:FCT:824’, ‘CGN:FCT:825’, ‘CGN:FCT:826’,
‘CGN:FCT:827’, ‘CGN:FCT:828’, ‘CGN:FCT:829’, ‘CGN:FCT:830’,
‘CGN:FCT:831’, ‘CGN:FCT:832’, ‘CGN:FCT:833’, ‘CGN:FCT:834’,
‘CGN:FCT:835’, ‘CGN:FCT:837’, ‘CGN:FCT:838’, ‘CGN:FCT:839’,
‘CGN:FCT:840’, ‘CGN:FCT:841’, ‘CGN:FCT:842’, ‘CGN:FCT:843’,
‘CGN:FCT:844’, ‘CGN:FCT:845’, ‘CGN:FCT:846’, ‘CGN:FCT:916’,
‘CGN:FCT:917’, ‘CGN:FCT:918’, ‘CGN:FCT:919’) AND
a.MODEL_JOB_EXECN_ID = (SELECT MAX(JOB_EXECN_ID) FROM
SAE_MDR.JOB) AND MEMBR_FACT_VALID_IND = ‘Y’ GROUP BY
a.RCD_TY_DESC, a.CHNL_SRC_CD, a.MODEL_JOB_’XE‘N_ID, a.FAC’_I‘,
a.SAE_LAS’_R‘N_DT, a.MOD’L_‘PLYMNT_ID O’DE‘ BY a.fact_id) t’st‘GROUP
BY te’t.‘ODEL_DPLYMN’_I‘) VAL1,sae_’dr‘model_dplym’t VAL2 where
VAL1.model_dplymnt_id=val2.model_dplymnt_id
CCDR_HEV_MART.CONDN_RISK_PROF_TFA_TKCDWHE2_PREV
select VAL2.model_id, VAL1.cnt from (SELECT
test.MODEL_DPLYMNT_ID,SUM (COUNT) AS CNT FROM ( SELECT
a.RCD_TY_DESC, a.CHNL_SRC_CD, COUNT
(*) AS COUNT, a.MODEL_JOB_EXECN_ID,
a.FACT_ID, a.MODEL_DPLYMNT_ID,
a.SAE_LAST_RUN_DT AS lastrun FROM
HEV_MART.CONDN_RISK_PROF a WHERE FACT_ID IN
(‘CGN:FCT:1052’, ‘CGN:FCT:1053’, ‘CGN:FCT:1054’, ‘CGN:FCT:1056’,
‘CGN:FCT:1057’, ‘CGN:FCT:1058’, ‘CGN:FCT:1059’, ‘CGN:FCT:1072’,
‘CGN:FCT:1073’, ‘CGN:FCT:1074’, ‘CGN:FCT:1075’, ‘CGN:FCT:1076’,
‘CGN:FCT:1077’, ‘CGN:FCT:1078’, ‘CGN:FCT:1079’, ‘CGN:FCT:1080’,
‘CGN:FCT:1081’, ‘CGN:FCT:1082’, ‘CGN:FCT:1083’, ‘CGN:FCT:1084’,
‘CGN:FCT:1085’, ‘CGN:FCT:1271’, ‘CGN:FCT:1272’, ‘CGN:FCT:1273’,
‘CGN:FCT:1274’, ‘CGN:FCT:1275’, ‘CGN:FCT:1276’, ‘CGN:FCT:1277’,
‘CGN:FCT:1278’, ‘CGN:FCT:1279’, ‘CGN:FCT:1280’, ‘CGN:FCT:1281’,
‘CGN:FCT:1282’, ‘CGN:FCT:1283’, ‘CGN:FCT:1284’, ‘CGN:FCT:1285’,
‘CGN:FCT:1286’, ‘CGN:FCT:1287’, ‘CGN:FCT:1288’, ‘CGN:FCT:1332’,
‘CGN:FCT:1333’, ‘CGN:FCT:1343’, ‘CGN:FCT:1344’, ‘CGN:FCT:1345’,
‘CGN:FCT:1346’, ‘CGN:FCT:1361’, ‘CGN:FCT:1362’, ‘CGN:FCT:1363’,
‘CGN:FCT:1376’, ‘CGN:FCT:1377’, ‘CGN:FCT:1383’, ‘CGN:FCT:1384’,
‘CGN:FCT:1385’, ‘CGN:FCT:1386’, ‘CGN:FCT:1387’, ‘CGN:FCT:1388’,
‘CGN:FCT:1433’, ‘CGN:FCT:1434’, ‘CGN:FCT:1435’, ‘CGN:FCT:1441’,
‘CGN:FCT:1442’, ‘CGN:FCT:1464’, ‘CGN:FCT:1465’, ‘CGN:FCT:1500’,
‘CGN:FCT:1501’, ‘CGN:FCT:1502’, ‘CGN:FCT:1503’, ‘CGN:FCT:1504’,
‘CGN:FCT:1511’, ‘CGN:FCT:1512’, ‘CGN:FCT:1513’, ‘CGN:FCT:1533’,
‘CGN:FCT:1534’, ‘CGN:FCT:1535’, ‘CGN:FCT:1536’, ‘CGN:FCT:1537’,
‘CGN:FCT:1538’, ‘CGN:FCT:1548’, ‘CGN:FCT:1549’, ‘CGN:FCT:1551’,
‘CGN:FCT:1552’, ‘CGN:FCT:1553’, ‘CGN:FCT:1554’, ‘CGN:FCT:1555’,
‘CGN:FCT:1556’, ‘CGN:FCT:1568’, ‘CGN:FCT:1569’, ‘CGN:FCT:1570’,
‘CGN:FCT:1571’, ‘CGN:FCT:1572’, ‘CGN:FCT:1573’, ‘CGN:FCT:1574’,
‘CGN:FCT:1579’, ‘CGN:FCT:1580’, ‘CGN:FCT:1583’, ‘CGN:FCT:1584’,
‘CGN:FCT:1585’, ‘CGN:FCT:1651’, ‘CGN:FCT:1655’, ‘CGN:FCT:1669’,
‘CGN:FCT:1670’, ‘CGN:FCT:1671’, ‘CGN:FCT:1672’, ‘CGN:FCT:1673’,
‘CGN:FCT:1725’, ‘CGN:FCT:1726’, ‘CGN:FCT:1727’, ‘CGN:FCT:1728’,
‘CGN:FCT:1729’, ‘CGN:FCT:1730’, ‘CGN:FCT:1731’, ‘CGN:FCT:1732’,
‘CGN:FCT:1747’, ‘CGN:FCT:1748’, ‘CGN:FCT:1749’, ‘CGN:FCT:1750’,
‘CGN:FCT:1759’, ‘CGN:FCT:1817’, ‘CGN:FCT:1818’, ‘CGN:FCT:1819’,
‘CGN:FCT:1820’, ‘CGN:FCT:1847’, ‘CGN:FCT:1848’, ‘CGN:FCT:1849’,
‘CGN:FCT:1850’, ‘CGN:FCT:748’, ‘CGN:FCT:749’, ‘CGN:FCT:750’,
‘CGN:FCT:751’, ‘CGN:FCT:752’, ‘CGN:FCT:753’, ‘CGN:FCT:754’,
‘CGN:FCT:755’, ‘CGN:FCT:756’, ‘CGN:FCT:757’, ‘CGN:FCT:758’,
‘CGN:FCT:759’, ‘CGN:FCT:760’, ‘CGN:FCT:761’, ‘CGN:FCT:762’,
‘CGN:FCT:763’, ‘CGN:FCT:764’, ‘CGN:FCT:765’, ‘CGN:FCT:766’,
‘CGN:FCT:767’, ‘CGN:FCT:768’, ‘CGN:FCT:769’, ‘CGN:FCT:770’,
‘CGN:FCT:771’, ‘CGN:FCT:772’, ‘CGN:FCT:773’, ‘CGN:FCT:774’,
‘CGN:FCT:775’, ‘CGN:FCT:776’, ‘CGN:FCT:777’, ‘CGN:FCT:778’,
‘CGN:FCT:779’, ‘CGN:FCT:780’, ‘CGN:FCT:781’, ‘CGN:FCT:782’,
‘CGN:FCT:783’, ‘CGN:FCT:784’, ‘CGN:FCT:785’, ‘CGN:FCT:786’,
‘CGN:FCT:787’, ‘CGN:FCT:788’, ‘CGN:FCT:789’, ‘CGN:FCT:790’,
‘CGN:FCT:791’, ‘CGN:FCT:792’, ‘CGN:FCT:793’, ‘CGN:FCT:794’,
‘CGN:FCT:795’, ‘CGN:FCT:796’, ‘CGN:FCT:797’, ‘CGN:FCT:798’,
‘CGN:FCT:799’, ‘CGN:FCT:800’, ‘CGN:FCT:801’, ‘CGN:FCT:802’,
‘CGN:FCT:803’, ‘CGN:FCT:804’, ‘CGN:FCT:805’, ‘CGN:FCT:806’,
‘CGN:FCT:807’, ‘CGN:FCT:808’, ‘CGN:FCT:809’, ‘CGN:FCT:810’,
‘CGN:FCT:811’, ‘CGN:FCT:812’, ‘CGN:FCT:813’, ‘CGN:FCT:814’,
‘CGN:FCT:815’, ‘CGN:FCT:816’, ‘CGN:FCT:817’, ‘CGN:FCT:818’,
‘CGN:FCT:819’, ‘CGN:FCT:820’, ‘CGN:FCT:821’, ‘CGN:FCT:822’,
‘CGN:FCT:823’, ‘CGN:FCT:824’, ‘CGN:FCT:825’, ‘CGN:FCT:826’,
‘CGN:FCT:827’, ‘CGN:FCT:828’, ‘CGN:FCT:829’, ‘CGN:FCT:830’,
‘CGN:FCT:831’, ‘CGN:FCT:832’, ‘CGN:FCT:833’, ‘CGN:FCT:834’,
‘CGN:FCT:835’, ‘CGN:FCT:837’, ‘CGN:FCT:838’, ‘CGN:FCT:839’,
‘CGN:FCT:840’, ‘CGN:FCT:841’, ‘CGN:FCT:842’, ‘CGN:FCT:843’,
‘CGN:FCT:844’, ‘CGN:FCT:845’, ‘CGN:FCT:846’, ‘CGN:FCT:916’,
‘CGN:FCT:917’, ‘CGN:FCT:918’, ‘CGN:FCT:919’) AND
a.MODEL_JOB_EXECN_ID =(SELECT MAX(JOB_EXECN_ID) FROM
SAE_MDR.JOB WHERE JOB_EXECN_ID < (SELECT MAX(JOB_EXECN_ID)
FROM SAE_MDR.JOB)) AND MEMBR_FACT_VALID_IND =
‘Y’ GROUP BY a.RCD TY_DESC,
a.CHNL_SRC_CD, a.MODEL_JOB_EXECN_ID,
a.FACT_ID, a.SAE_LAST_RUN_DT,
a.MODEL_DPLYMNT_ID ORDER BY a.fact_id) test GROUP BY
test. MODEL_DPLYMNT_ID) VAL1,sae_mdr.model_dplymnt VAL2 where
VAL1.model_dplymnt_id =val2.model_dplymnt_id

Week over Week Aggregate Analysis (WoW):

CCDR_HEV_MART.CONDN_RISK_PROF_WOW_TKCDWHE2_CURR
SELECT /*+ Parallel (a 16)*/ a.CHNL_SRC_CD, COUNT (*) as CNT,
a.MODEL_JOB_EXECN_ID FROM hev_mart.Condn_risk_prof_stg a WHERE
(a.MODEL_JOB_EXECN_ID IS NULL OR a.MODEL_JOB_EXECN_ID in
(SELECT MAX(JOB_EXECN_ID) FROM SAE_MDR.JOB)) and
CHNL_SRC_CD=’SAE’ group by a.CHNL_SRC_CD, a.MODEL_JOB_EXECN_ID
CCDR_HEV_MART.CONDN_RISK_PROF_WOW_TKCDWHE2_PREV
SELECT /*+ Parallel (a 16)*/ a.CHNL_SRC_CD, COUNT (*) as CNT,
a.MODEL_JOB_EXECN_ID FROM hev_mart.Condn_risk_prof a WHERE
(a.MODEL_JOB_EXECN_ID IS NULL OR a.MODEL_JOB_EXECN_ID IN
(SELECT MAX(JOB_EXECN_ID) FROM SAE_MDR.JOB WHERE
JOB_EXECN_ID < (SELECT MAX(JOB_EXECN_ID) FROM SAE_MDR.JOB)))
and CHNL_SRC_CD=’SAE’ group by a.CHNL_SRC_CD,
a.MODEL_JOB_EXECN_ID

### Pseudocode I

In some examples, the rules of the rule set 120 can include thresholds. An anomaly can be detected if source data 122 bypasses the threshold (e.g., if an amount of account cancellations reaches a first threshold, number of claims that are disapproved reaches a second threshold, number of claims that are approved reaches a third threshold, etc.). That is, characteristics of the source data 122 can be compared to thresholds to determine if the characteristics are anomalous. If so, an anomalous operation can be occurring. Thus, the data catalog platform 108 can detect when anomalies occur. The rules of the rule set 120 can be stored in association with batch identifications (IDs) that can be batch information. A batch ID is a unique identifier for a batch of transactions processed together. Batch IDs information provides the ownership and groups of incident tickets (e.g., “incident tickets” are assigned to anomalous data and/or processes once anomalies are detected in the anomalous data and/or processes). Incident tickets can indicate both the anomalous data and/or processes, as well as the specific anomaly of the anomalous data and/or processes.

The data catalog platform 108 can generate custom rules and alerts based on the particular characteristics of the dataset 118. For example, the data catalog platform 108 can create an alert which will be triggered if characteristics of the source data 122 bypass thresholds. Of note is that the data catalog platform 108 is adaptable to different industries (e.g., health care, data warehouses, airlines, automotive, etc.).

The data catalog platform 108 automatically passes metadata (e.g., batch IDs, data IDs of source data 122, rules associated with the data IDs, where the source data 122 is located, pointers to the source data 122, time stamps, rules and/or rule IDs etc.) for the dataset 118 periodically (e.g., daily, hourly, when anomalies are identified, etc.) to anomaly correction platform 110. In some examples, the metadata can be provided to the anomaly correction platform 110 in association with an application ID of an application that owns the source data 122. In some examples, the metadata describes the dataset 118 and the rule set 120, and the anomaly correction platform 110 can recreate (e.g., clone) the dataset 118 and the rule set 120 to be synchronized with the data catalog platform 108.

The anomaly correction platform 110 and the data catalog platform 108 can be optimized for different purposes. For example, the data catalog platform 108 can be a data governance platform that manages, protects, and maximizes the value of data assets. The data catalog platform 108 can be designed to enhance decision making by finding meaning in data of the data sources 102. The data catalog platform 108 can implement automated processes that don't require technical resources and support. The data catalog platform 108 can create an inventory of data assets, capture metadata about them, and govern the data, as well as help users monitor data quality and pipeline reliability to identify and fix anomalies. Thus, the data catalog platform 108 also provides a centralized place for defining, implementing, and tracking data policies and standards. Doing so helps organizations maintain compliance, operational efficiency and handles data responsibility.

The anomaly correction platform 110 can be a specialized tool to automate infrastructure technology (IT) processes, enabling the management of incidents, problems, changes, and service requests based on data from the data catalog platform 108. The anomaly correction platform 110 also enables systems that define, manage, automate, and structure IT services. Thus, the data catalog platform 108 (e.g., a first computer component) and the anomaly correction platform 110 (e.g., a second computer component distinct from the first computer component and independently operable of the first computer component) can operate together to establish a synergistic and efficient implementation to identify anomalies and heal the anomalies.

In some examples, a first application programming interface (API) associated with the data catalog platform 108 and a second API associated with the anomaly correction platform 110 facilitates communication between the data catalog platform 108 and the anomaly correction platform 110. In other words, communication can be accomplished through an API-to-API integration and schedules integration flow in an extract, transform, and load (ETL) tool. The anomaly correction platform 110 maintains a table of anomalous datasets and application identifiers that can be used for automation. The application identifier is linked to and/or associated with the batch IDs. The application identifier can identify a particular application that generated the anomalous data and/or implements the process of the batch IDs. Such data and applications can be flagged, healed, adjusted to remedy the anomalies, quarantined, controlled to cease operation, rolled back to a previous state from a current state (e.g., undo any software and/or hardware updates that occurred over a particular time period), etc.

During automation, a pipeline orchestrator 104 (e.g., Apache Airflow® and/or IBM® DataStage®) can trigger jobs (e.g., an automated process) through a third API. The pipeline orchestrator 104 can detect during the ESP jobs (e.g., batch jobs), source data 122 changing at the data sources 102 (e.g., pipeline sources and targets). Once the ESP jobs complete, an integration flow controller of pipeline orchestrator 104 (e.g., based on metadata stored in the dataset 118) triggers fourth APIs of the data catalog platform 108 (e.g., Data Quality API's), to initiate analysis based on rule set 120 (e.g., data quality rules) against the source data 122 of data sources 102 through edge agents 106.

Notably, triggering the fourth APIs of the data catalog platform 108 and/or initiating the analysis based on the rule set 120 based on the ESP jobs completion can provide significant enhancements. For example, errors (anomalies) can be readily identified and addressed rather than waiting for a user to notice such errors. Thus, examples can intervene prior to errors compounding and/or affecting many different systems. Furthermore, such automated processes can occur at any time of day, meaning that the automated error identification and remediation is not constrained to business hours or when humans are available, and consequently can occur in real time. Therefore, examples can more efficiently address the errors in real time with reduced processing power, reduced energy consumption, less memory consumption, and increased speed.

In some examples, the first API associated with the data catalog platform 108 (e.g., between the Data Quality Wrapper and Data Quality) and the second API associated with the anomaly correction platform 110 (between Data Quality and Incident creation process) facilitates communication between the data catalog platform 108 and the anomaly correction platform 110. During automation, the pipeline orchestrator 104 can trigger jobs (if not scheduled, for example, an automated process) through the third API (scheduling process automation). The pipeline orchestrator 104 can detect during the ESP jobs (e.g., batch jobs), source data 122 changing at the data sources 102 (e.g., pipeline sources and targets). Once the ESP jobs complete, an integration flow controller of pipeline orchestrator 104 (e.g., based on metadata stored in the dataset 118) triggers the fourth APIs of the data catalog platform 108 (e.g., Data Quality Wrapper API's), to initiate analysis based on rule set 120 (e.g., data quality rules) against the source data 122 of data sources 102 through edge agents 106.

The data catalog platform 108 can instruct the edge agents 106 to execute the rule set 120 on the data sources 102 based on ESP jobs. The edge agents 106 can be multi-language engines for executing data engineering, data science, and machine learning on single-node machines or clusters and can operate over various languages (e.g., execute Structured Query Language inquiries). The data sources 102 can be hosted on nodes 124. The edge agents 106 can execute on the nodes 124 in response to the ESP jobs being completed (e.g., triggered by the ESP job completion) to apply the rule set 120 to the dataset 118. A different one of the edge agents 106 can be executed for each of the different data sources 102. For example, a first of the edge agents 106 can be adapted for a first particular language or first structure of a first repository of the data sources 102 (e.g., medical claims), while a second of the edge agents 106 can be adapted for a second particular language or second structure of a second repository (e.g., health information) of the data sources 102. Thus, the edge agents 106 are implemented to operate over distinct criteria, structures and languages. The edge agents 106 can execute the rule set 120 to detect anomalies and any changes that have occurred on the source data 122. The edge agents 106 can operate over one table, multiple tables, and several distinct tables.

In executing the anomaly analysis on the nodes 124, significant amounts of data movement are reduced, and bandwidth is reduced. In contrast, if the data catalog platform 108 were to retrieve the source data 122 for analysis, significant amount of data movement would be incurred increasing bandwidth, latency and energy. For example, in such a scenario the nodes 124 would transmit the source data 122 to the data catalog platform 108, store the source data 122 on the to the data catalog platform 108 and analyze the source data 122 with the data catalog platform 108. Thus, the edge agents 106 are stored and executed on the nodes 124 that store the data sources 102 and can operate in parallel to further reduce the latency to analyze the source data 122 for anomalies while reducing bandwidth and energy.

In detail, the data catalog platform 108 can identify that the nodes 124 (e.g., servers, computing devices, computing architectures, hardware, circuitry, etc.) each store portions of the source data 122. The data catalog platform 108 then stores data processing execution code on the nodes 124 based on the nodes 124 storing the portions. The data processing execution code when executed by the nodes 124, implements the edge agents 106 to perform processing tasks on the source data 122 and distributes the processing tasks among the nodes 124 to analyze the different portions. When triggered by the execution of the ESP job, the data catalog platform 108 can cause the nodes 124 to execute the data processing execution code on the nodes 124 to identify characteristics of the source data 122. To determine whether the anomaly exists in the source data 122, the data catalog platform 108 analyzes the characteristics.

The nodes 124 and the edge agents 106 may therefore execute and implement the rule set 120 (e.g., queries) to determine if an anomaly exists. In some examples, the edge agents 106 can provide an indication of anomalies to the data catalog platform 108 along with a rule of the rule set 120 that is associated with the anomaly (e.g., the rule that indicates an anomaly when applied to the source data 122). In some examples, processing the queries includes identifying a command from the rule set that is a request to retrieve information from the source data 122, execute the command to retrieve the information from the source data, determine whether the information exceeds a threshold and determine that the anomaly exists when the information exceeds the threshold.

The data catalog platform 108 can compile results from the edge agents 106. If an anomaly is detected (e.g., an established alert thresholds is bypassed), the data catalog platform 108 can generate a ticket 116 and store the same on the anomaly correction platform 110. The ticket 116 is created and assigned to a listed group that is to correct and/or be notified of the anomaly (e.g., data owners, assignment group to remedy the anomaly, etc.). The metadata 114 for example can indicate a data owner associated with a particular rule and/or data of the source data 122 that is associated with the anomalous result (e.g., generated the anomalous result). The anomaly correction platform 110 can access the metadata 114 to identify the data owner and notify the data owner of the anomalous result and the particular rule that generated the anomalous result (e.g., present a notification indicating as much on a graphical user interface of a computing device). The ETL tool of the data catalog platform 108 can generate the ticket 116 and provide the ticket 116 to the anomaly correction platform 110. The ticket 116 can now be triaged and escalated based on pre-defined priorities. For example, reporting, alerts, automation and workflows can be implemented based on the priority.

Some examples can implement automation and/or self-healing. For example, examples can leverage robotic process automation 112 to perform self-healing by taking automated actions based on the queries identified by the data catalog platform 108. For example, the self-healing can include refreshing anomalous data (e.g., replacing corrupted copy of the data with non-corrupted data and flagging processes that occurred on the corrupted copy for further review), ceasing a computer process that is causing the anomaly, quarantining a virus that is causing the anomaly, re-executing a job (e.g., process) that cause the anomaly, etc. In some examples, the anomaly can be a delays and failures in data processing that is healed by re-initiating a batch job to execute the data processing. Thus, the self-healing mitigates if not all together removes the anomaly.

In some examples, the robotic process automation 112 includes automatically re-executing the automated process that generated the source data 122 in response to the anomaly being determined as existing. In some examples, the robotic process automation 112 includes automatically adjusting programing instructions of the automated process in response to the anomaly being determined as existing in addition to or instead of re-executing the automated process.

In some examples, the anomaly correction platform 110 includes a second machine learning model that is trained on previous tickets (which identify anomalies) and resolutions to the tickets. Thus, the second machine learning model analyzes the ticket 116 and can appropriately resolve the abnormality identified in the ticket 116. In some examples, the dataset 118 includes a first machine learning model that is trained to generate tickets based on anomalies and rules that generate the rule set 120. One example can include a production incident related to member resynchronization. The description can state the production incident with clarity. Typically, the support team would have numerous exchanges to determine the production incident and may take substantial time (e.g., weeks) to figure the cause and perform member resynchronization. In this case, the anomaly correction platform 110 can learn from past incident related to members discrepancies and perform an action to perform resynchronization of the members through self-healing leading to substantial time savings since the anomaly correction platform 110 can operate in real time to remedy the errors.

The first and/or second machine learning model can be implemented according to the machine learning model 1400 (FIG. 6) and/or neural network 1502 (FIG. 7) described below.

In the foregoing, the automated anomaly detection and correction system 100 can dynamically detect errors in real time and correct the errors. Doing so can reduce the number of tickets that are created (e.g., reduces storage space to store tickets), and further enhances operational flows by reducing if not altogether eliminating downtime as well as resources to mitigate errors. Thus, the automated anomaly detection and correction system 100 provides technical enhancements over existing systems which results in tangible benefits (e.g., millions of dollars in savings, massive reduction in requests for computing assistance or tickets, and elimination of human intervention, etc.).

Specific use cases are also described. As one use case, a pharmacy rebate data is normally loaded from a program, and manually checked for completeness by business users (not real time and error prone). When data is missing for key fields the data is reloaded from source. Examples herein can execute automated freshness and/or completeness checks within in near real time to the data pipeline executing. Doing so checks to ensure there are no records being dropped. If an issue is detected then examples can automatically reload the data.

As another use case, a customer repository data mart is the repository that feeds an Analytics Platform (AP). AP is a system that provides data-drive insights regarding the impact of our various physical programs (e.g., wellness programs) as it relates to customer's employee's health. Such insights are obtained by reports referred to as “slides”. Out of over seven hundred slides, over 90% had issues resulting in massive impact to reporting for the clients. The cause is that around three million claim records were not loaded due to a pipeline failure. The average volume of claim records loaded is at around 980 million, so the records dropped (3 million) was less than 1% of the average volume. This also means that the issue was not discovered in earlier stage and the loaded data was presumed to be live. Once the slides started generating, most of the reports were showing incorrect/inaccurate data for multiple slides for different clients. Examples can execute automated freshness and/or completeness checks in near real time to the data pipeline executing. Doing so checks to ensure there are no records being dropped. If an issue is detected then immediately heal the data by reloading and/or escalating.

As another use case, due to an unscheduled infrastructure outage, health risk assessments (HRA) daily batch load process into a Consumer Centric Data Repository (CCDR) failed and impacted the data loaded for that particular cycle. Since the successor jobs continued to operate, the issue was unnoticed for almost 10 days until the customers and/or members started creating tickets stating their HRA data is missing. This situation caused negative experiences for customers and delays in incentive payout. Examples execute automated freshness and/or completeness checks between in near real time to the data pipeline executing. This checks to ensure there are no records being dropped. If an issue is detected, then immediately heal the data by reloading and/or escalating.

It is to be noted that any and/or all of the electronic components of automated anomaly detection and correction system 100 can be implemented in in logic instructions (e.g., software), configurable logic, fixed-functionality hardware logic, computer readable instructions stored on at least one non-transitory computer readable storage medium that are executable to automated anomaly detection and correction system 100, circuitry, etc., or any combination thereof.

It is worth noting that any and/or all of the electronic components of can communicate over a network(s). The network(s) can include, or operate in conjunction with, an ad hoc network, an intranet, an extranet, a virtual private network (VPN), a local area network (LAN), a wireless network, a low energy Bluetooth (BLE) connection, a Wi-Fi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

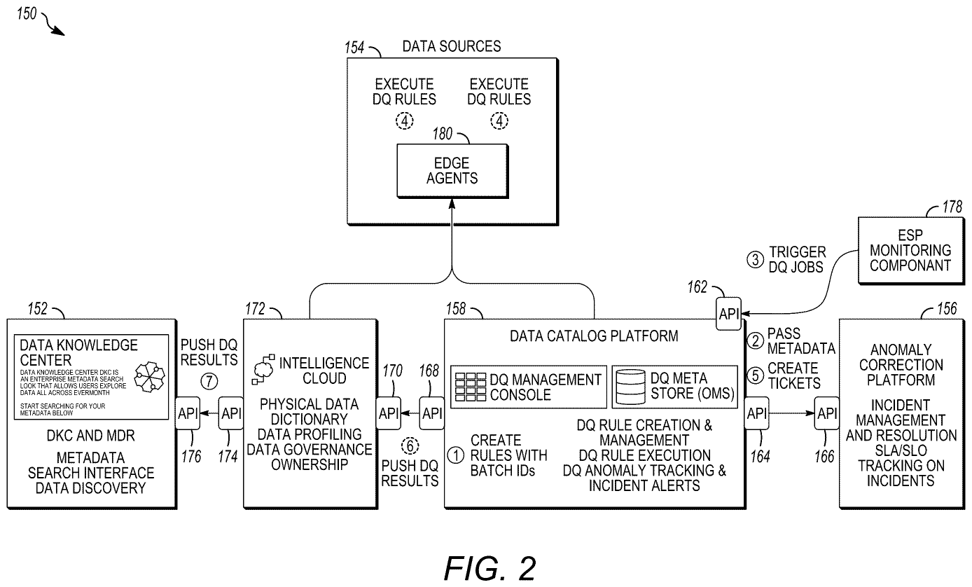

Turning now to FIG. 2, a data quality measurement process 150 is illustrated. In this example, a data catalog platform 158 generates data quality rules (e.g., even thresholds) and a metadata store. The metadata store can link particular rules to data entities (e.g., data owners) and existing batch IDs. The metadata store can effectively connect an anomaly to a data entity based on a rule that was applied to identify the anomaly. The batch ID links to the owner of the application who, in some examples, defined the rules later used for anomalies detection and escalation on the incident ticket.

The data catalog platform 158 can store the metadata in the anomaly correction platform 156 through APIs 164, 166. The APIs 164, 166 can be a feature to build integration from the data catalog platform 158 to the anomaly correction platform 156. The integration can validate batch IDs, pass rules, pass metadata and create tickets.

An ESP monitoring component 178 can detect when events (e.g., processes that change data) occur. When the ESP monitoring component 178 determines that such an event has occurred, the ESP monitoring component 178 triggers a data quality job in the data catalog platform 158 through API 162. The API 162 can be a feature to build integration that will execute data catalog platform 158 rules based on ESP monitoring and a batch ID key. The data quality job includes the data catalog platform 158 causing the edge agents 180 of data sources 154 (e.g., Teradata® and/or Oracle®) to execute the rules (e.g., data quality rules) on relevant data to identify anomalies. The data catalog platform 158 can create tickets describing the anomalies that are detected by the edge agents 180. The data catalog platform 158 can include a feature to build data quality rules and event thresholds, and align the rules with existing batch IDs (e.g., on Collibra®). The tickets can then be stored on the anomaly correction platform 156 via APIs 164, 166. In this example, the data catalog platform 158 can also notify an intelligence cloud 172 (e.g., physical data dictionary, data profiling and data governance ownership, etc.) via APIs 168, 170 of data quality results and/or tickets. The APIs 164, 166 can build integration between different platforms (e.g., Collibra® and Snow®). The integration can validate batch IDs, pass rule metadata and create tickets within an event manager.

A data knowledge center 152 can be modified to establish a user interface that displays the anomalies to a data owner of anomalies and receives the data quality results and/or tickets from the intelligence cloud 172. APIs 174, 176 can be features to build integration between the intelligence cloud and the knowledge center to pass data quality results.

It is to be noted that any and/or all of the electronic components of data quality measurement process 150 can be implemented in in logic instructions (e.g., software), configurable logic, fixed-functionality hardware logic, computer readable instructions stored on at least one non-transitory computer readable storage medium that are executable to implement data quality measurement process 150 circuitry, etc., or any combination thereof.

It is worth noting that any and/or all of the electronic components of can communicate over a network(s). The network(s) can include, or operate in conjunction with, an ad hoc network, an intranet, an extranet, a virtual private network (VPN), a local area network (LAN), a wireless network, a low energy Bluetooth (BLE) connection, a Wi-Fi 33 direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

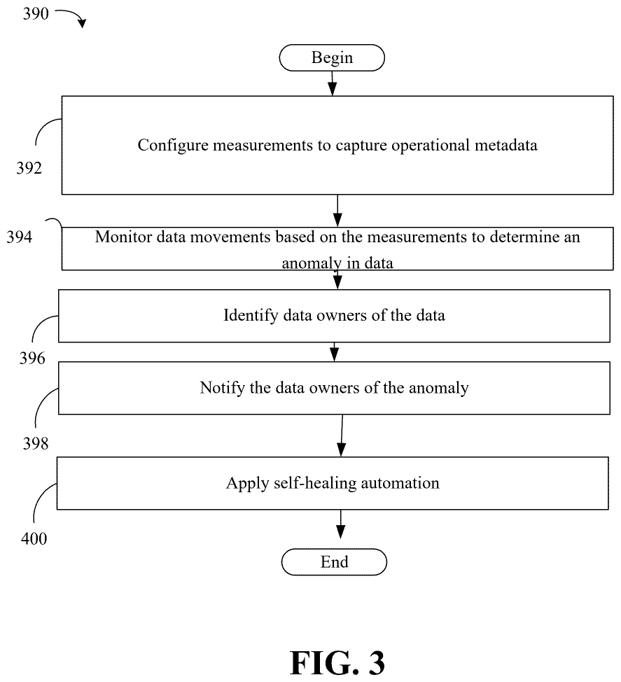

FIG. 3 illustrates a method 390 of identifying and healing anomalies. The method 390 can generally be implemented in conjunction with any of the examples described herein, for example automated anomaly detection and correction system 100 (FIG. 1), and/or data quality measurement process 150 (FIG. 2). The method 390 can be implemented in in logic instructions (e.g., software), configurable logic, fixed-functionality hardware logic, computer readable instructions stored on at least one non-transitory computer readable storage medium that are executable to implement method 390, circuitry, etc., or any combination thereof.

Illustrated processing block 392 configures measurements to capture operational metadata (e.g., characteristics of data). Processing block 392 can include leveraging thresholds to measure data quality. Illustrated processing block 394 monitors data movements (e.g., on a regular frequency) based on the measurements to determine an anomaly in data that could impact operational performance. Illustrated processing block 396 identifies data owners of the data (e.g., anomalous data). Illustrated processing block 398 notifies the data owners of the anomaly. Illustrated processing block 400 applies self-healing automation as described herein to heal the anomaly.

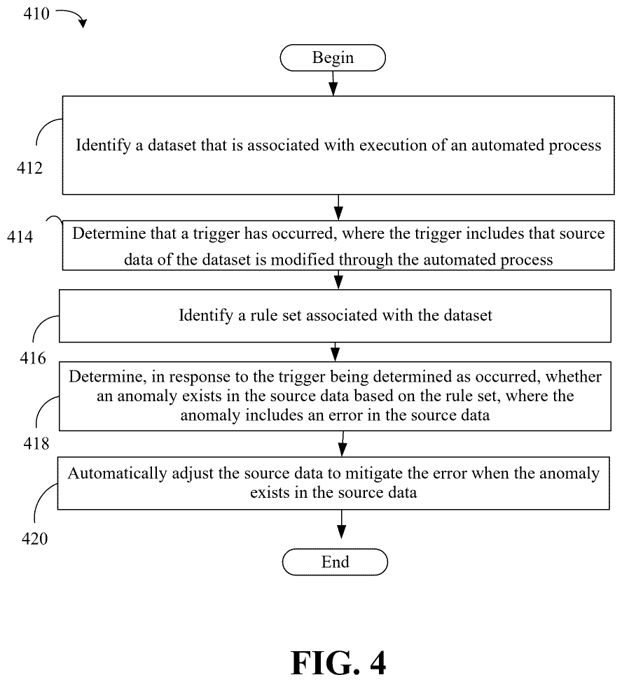

FIG. 4 illustrates a method 410 of data quality assessment and anomaly healing. The method 410 can generally be implemented in conjunction with any of the examples described herein, for example automated anomaly detection and correction system 100 (FIG. 1), data quality measurement process 150 (FIG. 2), and/or method 390 (FIG. 3). The method 410 can be implemented in in logic instructions (e.g., software), configurable logic, fixed-functionality hardware logic, computer readable instructions stored on at least one non-transitory computer readable storage medium that are executable to implement method 390, circuitry, etc., or any combination thereof.

Illustrated processing block 412 identifies a dataset that is associated with execution of an automated process. Illustrated processing block 414 determines that a trigger has occurred, where the trigger includes that source data of the dataset is modified through the automated process. Illustrated processing block 416 identifies a rule set associated with the dataset. Illustrated processing block 418 determines, in response to the trigger being determined as occurred, whether an anomaly exists in the source data based on the rule set, where the anomaly includes an error in the source data. Illustrated processing block 418 automatically adjusts the source data to mitigate the error when the anomaly exists in the source data.

In some examples, the method 410 receives, with a generative artificial intelligence model, a natural language prompt associated with identification of the anomaly, generates, with the generative artificial intelligence model, computer code to identify the anomaly based on the natural language prompt, and stores the computer code into the rule set. In some examples, the processing block 420 includes automatically re-executing the automated process in response to the anomaly being determined as existing. In some examples, processing block 420 includes automatically adjusting programing instructions of the automated process in response to the anomaly being determined as existing, where the source data is associated with healthcare data.

In some examples, the method 410 includes identifying nodes that store portions of the source data, storing data processing execution code on the nodes based on the nodes storing the portions, where the data processing execution code when executed, performs processing tasks on the source data, and executing the data processing execution code on the nodes to identify characteristics of the source data. The determining whether the anomaly exists in the source data, includes analyzing the characteristics.

In some examples, the method 410 includes training a first machine learning model based on previous errors from historical source data, generating the rule set with the first machine learning model, and training a second machine learning model based on previous mitigations to the previous errors. The adjusting the source data to mitigate the error includes automatically correcting the error based on an output of the second machine learning model.

In some examples the determining whether the anomaly exists in the source data based on the rule includes identifying a command from the rule set that is a request to retrieve information from the source data, executing the command to retrieve the information from the source data, determining whether the information exceeds a threshold, and determining that the anomaly exists when the information exceeds the threshold.

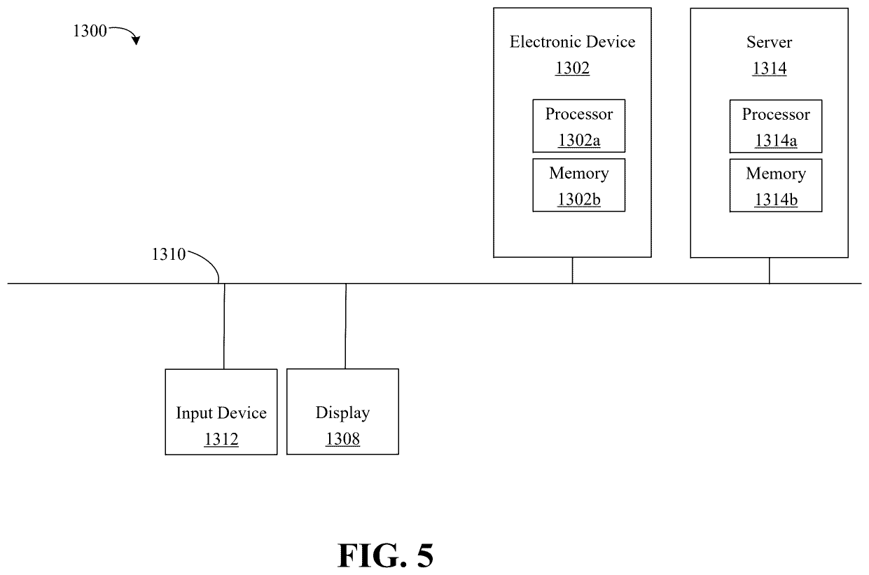

FIG. 5 shows a more detailed example of a computing architecture 1300 to execute a compliance process. The computing architecture 1300 can generally be implemented in conjunction with any of the examples described herein, for example for example automated anomaly detection and correction system 100 (FIG. 1), data quality measurement process 150 (FIG. 2), method 390 (FIG. 3) and/or method 410 (FIG. 4).

In the illustrated example, the computing architecture 1300 can include a network 1310 that can facilitate communication between server 1314, electronic device 1302 (e.g., part of a network), input device 1312, and display 1308. The display 1308 (e.g., audio and/or visual interface) can present anomaly notifications to a user, and the input device 1312 can receive user inputs (e.g., anomaly related inquiries, anomaly remediation, anomaly testing, etc.).

The server 1314 includes a processor 1314a (e.g., embedded controller, central processing unit/CPU) and a memory 1314b (e.g., non-volatile memory/NVM and/or volatile memory) containing a set of instructions, which when executed by the processor 1314a, cause the server 1314 to implement aspects described herein. For example, the processor 1314a can generate rules, monitor data for anomalies based on the rules and mitigation the anomalies and/or notify a user of the anomalies via the display 1308.

The electronic device 1302 includes a processor 1302a (e.g., embedded controller, central processing unit/CPU) and a memory 1302b (e.g., non-volatile memory/NVM and/or volatile memory) containing a set of instructions, which when executed by the processor 1302a, cause the electronic device 1302 to implement aspects described herein.

Example systems and methods for anomaly analysis in a computerized framework herein. In some examples, the computing systems relate to healthcare in which providers are healthcare providers and consumers are patients, although not all examples of the inventive subject matter are limited to healthcare services. In such examples, maintaining secure and robust computer architectures enables the provisioning of services at scale. Some examples may be used in connection with other types of services and/or industries, such as legal counseling, financial advisement services, retail sales, computer troubleshooting, computer engineering, or the like. Users of computer architectures may interact with each other via online communications, emails, data storage, videoconferences, teleconferences channels (e.g., using electronic communication devices connected over a communication network or channel). Users may access the computer architectures via an electronic communication device such as a mobile phone, tablet computer, laptop computer, desktop computer, smart television, or the like.

FIG. 6 is a block diagram of an example service of a machine learning model 1400 that may be deployed within for example automated anomaly detection and correction system 100 (FIG. 1), data quality measurement process 150 (FIG. 2), method 390 (FIG. 3), method 410 (FIG. 4) and/or computing architecture 1300 (FIG. 5).

Training input 1410 includes model parameters 1412 and training data 1420, which may include paired training datasets 1422 (e.g., input-output training pairs) and constraints 1426. Model parameters 1412 store or provide the parameters or coefficients of corresponding ones of machine learning models. During training, these parameters 1412 are adapted based on the input-output training pairs of the training datasets 1422. After the model parameters 1412 are adapted (after training), the model parameters 1412 are used by trained models 1460 to implement the trained machine learning models on a new set of data 1470 (e.g., for auditing).

Training data 1420 includes constraints 1426 which may define the constraints of a given patient information features. The paired training datasets 1422 may include sets of input-output pairs, such as pairs of a plurality of training compliance bundle features and features of compliance documents that are created in association with one or more of the training data (e.g., ground-truth non-compliance and compliance). Some components of training input 1410 may be stored separately at a different off-site facility or facilities than other components.

Machine learning model(s) training 1430 trains one or more machine learning techniques based on the sets of input-output pairs of paired training datasets 1422. For example, the model training 1430 may train the machine learning (ML) model parameters 1412 by minimizing a loss function based on one or more ground-truth patient encounter documents generated in association with a training transcription. The ML model can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, an LLM, a generative network, a diffusion model, and the like.

Particularly, the ML model can be applied to a training batch of audit and compliance features to estimate or generate one or more preliminary compliance documents, compliance documents, non-compliance documents and/or security documents. In some implementations, a derivative of a loss function is computed based on a comparison of the one or more preliminary compliance documents, compliance documents, non-compliance documents and/or security documents and the ground truth compliance, compliance, non-compliance and/or security documents associated with the training batch of audit and compliance features and parameters of the ML model are updated based on the computed derivative of the loss function.

The result of minimizing the loss function for multiple sets of training data trains, adapts, or optimizes the model parameters 1412 of the corresponding ML models. In this way, the ML model is trained to establish a relationship between a plurality of training features and ground-truth compliance and/or security outcomes (e.g., compliance results).

After the machine learning model is trained, new data 1470, including one or more preliminary compliance documents and/or security documents are received and/or derived. The trained machine learning model may be applied to the new data 1470 to generate results 1480 including a compliance result, compliance decision, and/or non-compliance decision. The compliance data (e.g., compliance result, compliance bundle, compliance decision, non-compliance decision0 can be represented in a GUI, such as in a prompt overlaid on the GUI allowing a security technician to selectively remediate and/or analyze security flaws.

FIG. 7 is a functional block diagram of an example neural network 1502 that can be used for the inference engine or other functions (e.g., engines) as described herein to produce a machine learning model to determine compliance. The neural network 1502 can be included as part of automated anomaly detection and correction system 100 (FIG. 1), data quality measurement process 150 (FIG. 2), method 390 (FIG. 3), method 410 (FIG. 4) and/or computing architecture 1300 (FIG. 5), according to some examples. The machine learning model can identify or generate compliance results, non-compliance and compliance decisions, and/or obtain information related to compliance. In an example, the neural network 1502 can be a LSTM neural network. In an example, the neural network 1502 can be a recurrent neural network (RNN). The example neural network 1502 may be used to implement the machine learning as described herein, and various implementations may use other types of machine learning networks. The neural network 1502 includes an input layer 1504, a hidden layer 1508, and an output layer 1512. The input layer 1504 includes inputs 1504a, 1504b . . . 1504n. The hidden layer 1508 includes neurons 1508a, 1508b . . . 1508n. The output layer 1512 includes outputs 1512a, 1512b . . . 1512n.

Each neuron of the hidden layer 1508 receives an input from the input layer 1504 and outputs a value to the corresponding output in the output layer 1512. For example, the neuron 1508a receives an input from the input 1504a and outputs a value to the output 1512a. Each neuron, other than the neuron 1508a, also receives an output of a previous neuron as an input. For example, the neuron 1508b receives inputs from the input 1504b and the output 1512a. In this way the output of each neuron is fed forward to the next neuron in the hidden layer 1508. The last output 1512n in the output layer 1512 outputs a probability associated with the inputs 1504a-1504n. Although the input layer 1504, the hidden layer 1508, and the output layer 1512 are depicted as each including three elements, each layer may contain any number of elements. Neurons can include one or more adjustable parameters, weights, rules, criteria, or the like.

In various implementations, each layer of the neural network 1502 must include the same number of elements as each of the other layers of the neural network 1502. For example, training GUI features (e.g., fields of a GUI presented to an operator) may be processed to create the inputs 1504a-1504n. The neural network 1502 may implement a model to produce one or more preliminary compliance results in association with the compliance features. More specifically, the inputs 1504a-1504n can include fields of the compliance features (binary, vectors, factors or the like) stored in the storage device. The fields of the compliance features can be data features that are be provided to neurons 1508a-1508n for analysis and connections between the known facts. The neurons 1508a-1508n, upon finding connections, provides the potential connections as outputs to the output layer 1512, which determines a compliance result, compliance, non-compliance, etc.

The neural network 1502 can perform any of the above calculations. The output of the neural network 1502 can be used to trigger display of a prompt that includes the compliance result document in a GUI. For example, the prompt (e.g., notification) can be provided to an auditor, security analyst, programmer, etc.

In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 1504a is connected to each of neurons 1508a, 1508b . . . 1508n.

The present systems and methods (e.g., ML models) can identify a dataset that is associated with execution of an automated process, determine that a trigger has occurred, where the trigger includes that source data of the dataset is modified through the automated process and identify a rule set associated with the dataset. in response to the trigger being determined as occurred, the present systems and methods determine whether an anomaly exists in the source data based on the rule set, where the anomaly includes an error in the source data, and automatically adjust the source data to mitigate the error when the anomaly exists in the source data.

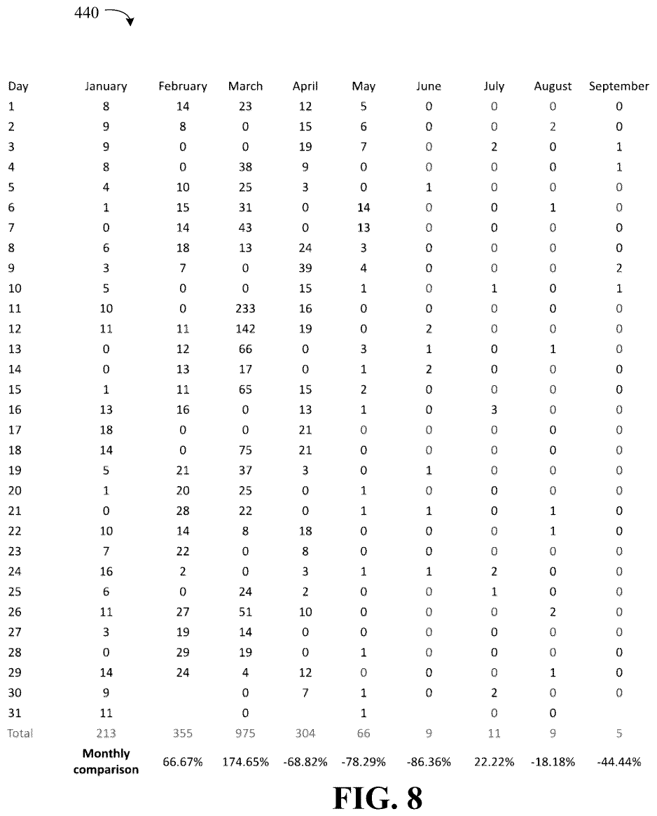

FIG. 8 illustrates a table 440 illustrating the result of technical solutions according to examples herein on IBOR (Individual Book Of Record) which is a report comparing the monthly incidents during a year. It can be seen that the number of incidents significantly reduced starting in April after technical solutions described herein were implemented. Indeed, incidents were reduced to significantly lower numbers.

In this case, it is possible to measure operation efficiencies by comparing the incidents which reduced customer eligibility issues, reduced downtime and reduced the manual work across multiple teams. For example, the monthly incident comparison for IBOR related to CED member resync incidents. As is observable since May, examples have reduced thousands of tickets compared to a situation in which the examples herein are not applied. In recent months most of the days have either 1 or 0 incident. In September, there are only 5 production incidents which is the lowest month ever for IBOR team. This solution is estimated to already have reduced down time by significant hours and saved millions of dollars for the enterprise. This is obvious by looking at percentages of the incident's comparison month by month which is usually a negative decrease. “COMPONENT” in this context refers to a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein.

A hardware component can also be implemented mechanically, electronically, or any suitable combination thereof. For example, a hardware component can include dedicated circuitry or logic that is permanently configured to perform certain operations. A hardware component can be a special-purpose processor, such as a Field-Programmable Gate Array (FPGA) or an ASIC. A hardware component can also include programmable logic or circuitry that is temporarily configured by software to perform certain operations. For example, a hardware component can include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) can be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output.

Hardware components can also initiate communications with input or output devices and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” refers to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some example examples, the processors or processor-implemented components can be located in a single geographic location (e.g., within a home environment, an office environment, or a server farm). In other example examples, the processors or processor-implemented components can be distributed across a number of geographic locations.

The term “coupled” can be used herein to refer to any type of relationship, direct or indirect, between the components in question, and can apply to electrical, mechanical, fluid, optical, electromagnetic, electromechanical or other connections. In addition, the terms “first”, “second”, etc. can be used herein only to facilitate discussion, and carry no particular temporal or chronological significance unless otherwise indicated.

Those skilled in the art will appreciate from the foregoing description that the broad techniques of the examples of the present disclosure can be implemented in a variety of forms. Therefore, while the examples of this disclosure have been described in connection with particular examples thereof, the true scope of the examples of the disclosure should not be so limited since other modifications will become apparent to the skilled practitioner upon a study of the drawings, specification, and following claims.

We claim:

1. A computing system comprising:
a processor; and
a memory having a set of instructions, which when executed by the processor, cause the computing system to:
identify a dataset that is associated with execution of an automated process;
determine that a trigger has occurred, wherein the trigger includes that source data of the dataset is modified through the automated process;
identify a rule set associated with the dataset;
in response to the trigger being determined as occurred, determine whether an anomaly exists in the source data based on the rule set, wherein the anomaly includes an error in the source data; and
automatically adjust the source data to mitigate the error when the anomaly exists in the source data.

2. The computing system of claim 1, wherein the instructions of the memory, when executed, cause the computing system to:
receive, with a generative artificial intelligence model, a natural language prompt associated with identification of the anomaly;
generate, with the generative artificial intelligence model, computer code to identify the anomaly based on the natural language prompt; and
store the computer code into the rule set.

3. The computing system of claim 1, wherein the instructions of the memory, when executed, cause the computing system to:
automatically re-execute the automated process in response to the anomaly being determined as existing.

4. The computing system of claim 1, wherein the instructions of the memory, when executed, cause the computing system to:
automatically adjust programing instructions of the automated process in response to the anomaly being determined as existing,
wherein the source data is associated with healthcare data.

5. The computing system of claim 1, wherein the instructions of the memory, when executed, cause the computing system to:
identify nodes that store portions of the source data;
store data processing execution code on the nodes based on the nodes storing the portions, wherein the data processing execution code when executed, performs processing tasks on the source data; and
execute the data processing execution code on the nodes to identify characteristics of the source data;
wherein to determine whether the anomaly exists in the source data, the instructions of the memory, when executed, cause the computing system to analyze the characteristics.

6. The computing system of claim 1, wherein the instructions of the memory, when executed, cause the computing system to:
train a first machine learning model based on previous errors from historical source data;
generate the rule set with the first machine learning model; and
train a second machine learning model based on previous mitigations to the previous errors;
wherein to automatically adjust the source data to mitigate the error, the instructions of the memory, when executed, cause the computing system to automatically correct the error based on an output of the second machine learning model.

7. The computing system of claim 1, wherein to determine whether the anomaly exists in the source data based on the rule set, the instructions of the memory, when executed, cause the computing system to:
identify a command from the rule set that is a request to retrieve information from the source data;
execute the command to retrieve the information from the source data;
determine whether the information exceeds a threshold; and
determine that the anomaly exists when the information exceeds the threshold.

8. At least one non-transitory computer readable storage medium comprising a set of instructions, which when executed by a computing system, cause the computing system to:
identify a dataset that is associated with execution of an automated process;
determine that a trigger has occurred, wherein the trigger includes that source data of the dataset is modified through the automated process;
identify a rule set associated with the dataset;
in response to the trigger being determined as occurred, determine whether an anomaly exists in the source data based on the rule set, wherein the anomaly includes an error in the source data; and
automatically adjust the source data to mitigate the error when the anomaly exists in the source data.

9. The at least one non-transitory computer readable storage medium of claim 8, wherein the instructions, when executed, cause the computing system to:
receive, with a generative artificial intelligence model, a natural language prompt associated with identification of the anomaly;
generate, with the generative artificial intelligence model, computer code to identify the anomaly based on the natural language prompt; and
store the computer code into the rule set.

10. The at least one non-transitory computer readable storage medium of claim 8, wherein the instructions, when executed, cause the computing system to:
automatically re-execute the automated process in response to the anomaly being determined as existing.

11. The at least one non-transitory computer readable storage medium of claim 8, wherein the instructions, when executed, cause the computing system to:
automatically adjust programing instructions of the automated process in response to the anomaly being determined as existing,
wherein the source data is associated with healthcare data.

12. The at least one non-transitory computer readable storage medium of claim 8, wherein the instructions, when executed, cause the computing system to:
identify nodes that store portions of the source data;
store data processing execution code on the nodes based on the nodes storing the portions, wherein the data processing execution code when executed, performs processing tasks on the source data; and
execute the data processing execution code on the nodes to identify characteristics of the source data;
wherein to determine whether the anomaly exists in the source data, the instructions, when executed, cause the computing system to analyze the characteristics.

13. The at least one non-transitory computer readable storage medium of claim 8, wherein the instructions, when executed, cause the computing system to:
train a first machine learning model based on previous errors from historical source data;
generate the rule set with the first machine learning model; and
train a second machine learning model based on previous mitigations to the previous errors;
wherein to automatically adjust the source data to mitigate the error, the instructions, when executed, cause the computing system to automatically correct the error based on an output of the second machine learning model.

14. The at least one non-transitory computer readable storage medium of claim 8, wherein to determine whether the anomaly exists in the source data based on the rule set, the instructions, when executed, cause the computing system to:
identify a command from the rule set that is a request to retrieve information from the source data;
execute the command to retrieve the information from the source data;
determine whether the information exceeds a threshold; and
determine that the anomaly exists when the information exceeds the threshold.

15. A method comprising:
identifying a dataset that is associated with execution of an automated process;
determining that a trigger has occurred, wherein the trigger includes that source data of the dataset is modified through the automated process;
identifying a rule set associated with the dataset;
in response to the trigger being determined as occurred, determining whether an anomaly exists in the source data based on the rule set, wherein the anomaly includes an error in the source data; and
automatically adjusting the source data to mitigate the error when the anomaly exists in the source data.

16. The method of claim 15, comprising:
receiving, with a generative artificial intelligence model, a natural language prompt associated with identification of the anomaly;
generating, with the generative artificial intelligence model, computer code to identify the anomaly based on the natural language prompt; and
storing the computer code into the rule set.

17. The method of claim 15, comprising:
automatically re-executing the automated process in response to the anomaly being determined as existing.

18. The method of claim 15, comprising:
automatically adjusting programing instructions of the automated process in response to the anomaly being determined as existing,
wherein the source data is associated with healthcare data.

19. The method of claim 15, comprising:
identifying nodes that store portions of the source data;
storing data processing execution code on the nodes based on the nodes storing the portions, wherein the data processing execution code when executed, performs processing tasks on the source data; and
executing the data processing execution code on the nodes to identify characteristics of the source data;
wherein the determining whether the anomaly exists in the source data comprises analyzing the characteristics.

20. The method of claim 15, comprising:
training a first machine learning model based on previous errors from historical source data;
generating the rule set with the first machine learning model; and
training a second machine learning model based on previous mitigations to the previous errors;
wherein the automatically adjusting the source data to mitigate the error comprises automatically correcting the error based on an output of the second machine learning model.
